(19) United States
(12) Patent Application Publication
(10) Pub. No.: US 2010/0025540 A1
(43) Pub. Date: Feb. 4, 2010

(54) Compact ultralight aircraft reduced dimensions, with vertical take-off and landing

(76) Inventor: Fabrizio Castoldi, Milan (IT)

Correspondence Address: HEDMAN & COSTIGAN P.C., 1185 AVENUE OF THE AMERICAS, NEW YORK, NY, 10036, US

(21) Appl. No.: 12/311,984

(22) PCT Filed: Nov. 12, 2007
(86) PCT No.: PCT/IB2007/003522

§ 371 Date: Apr. 20, 2009

(30) Foreign Application Priority Data
Nov. 13, 2006 (IT) M12006A 002174

(51) Int. Cl. B64C 27/20; B64C 27/10; B64C 29/00; B64C 39/02

(52) U.S. Cl. 244/23 C

(57) ABSTRACT

A compact ultralight aircraft (10) comprising two coaxial counter-rotating rotors (11, 11′) to each one which at least two rigid blades (12) are connected, centrally ducted in a cylindrical structure (13), of a radius substantially slightly greater than the size of said rigid blades (12), and rotated by an engine (14), through driving means (21), a compartment (15) rigidly connected to the cylindrical structure (13), the aircraft (10) further comprising at least two series of parallel rows of flaps (18′, 18″) arranged orthogonal to each other to form a grid, the at least two series of parallel rows of flaps (18′, 18″) being joined and contained in the cylindrical structure (13) in various cylindrical sections one over the other, each of the parallel rows (18′, 18″) being composed by at least two flaps (18′A, 18′B; 18″A, 18″B)in series.

The present invention refers to a compact single or double seat aircraft, remote controlled without people on board, with a rotating wing.

Currently there are numerous, and very different, models of single or double seat aircrafts, remote controlled without people on board, with rotating wings.

However, in general, in all existing models of helicopters the control of the direction is ensured by the control of the angle of attack of the rotating blades with the rotors provided in the upper portions of the helicopters.

As a matter of fact, by operating on the pitch of the rotating blades, through cyclical and/or collective variations, it is possible to generate forces and resulting torques such to allow the equilibrium of the aircraft in flight, and its relative control, with respect to the three roll axis, longitudinal to the forward motion, pitching axis, transverse to forward motion and yaw axis, usually even by means of a tail rotor.

However, though commonly applied and functional, such solution is not very suitable to reduce the dimensions and overall weights of the aircraft.

As a matter of fact, by reducing the weights below a limit value it is possible to fall in the range of aircrafts, so called ultralight, regulated by some advantageous measures such as for example the exemption from the obligation to submit flight plans before taking off.

In addition, current aircrafts have a serious problem regarding risks involved in using a tail rotor and the presence of one or more main rotors, particularly for small aircrafts where the height of the rotors, when the aircraft is on the ground, is equivalent to the one of an adult human.

An objective of the present invention is to manufacture a device capable of overcoming the abovementioned drawbacks of the known art in an extremely simple, economical and particularly functional manner.

Another objective is to manufacture a compact single or double seat aircraft, remote controlled without people on board, whose controllability is ensured by at least two series of rows of flaps arranged orthogonal to each other.

Further objective is to provide a compact single or double seat aircraft, remote controlled without people on board, capable of reducing problems regarding risks involved in using a tail rotor and the presence of unshielded rotors.

These objectives according the present invention are attained by manufacturing a compact single or double seat aircraft, remote controlled without people on board, with a rotating wing as described in claim 1.

Further characteristics of the invention are described by the subsequent claims.

Characteristics and advantages of a compact single or double seat aircraft, remote controlled without people on board, with a rotating wing according to the present invention shall be more evident from the following exemplifying and non-limiting description with reference to the schematic drawings attached wherein:

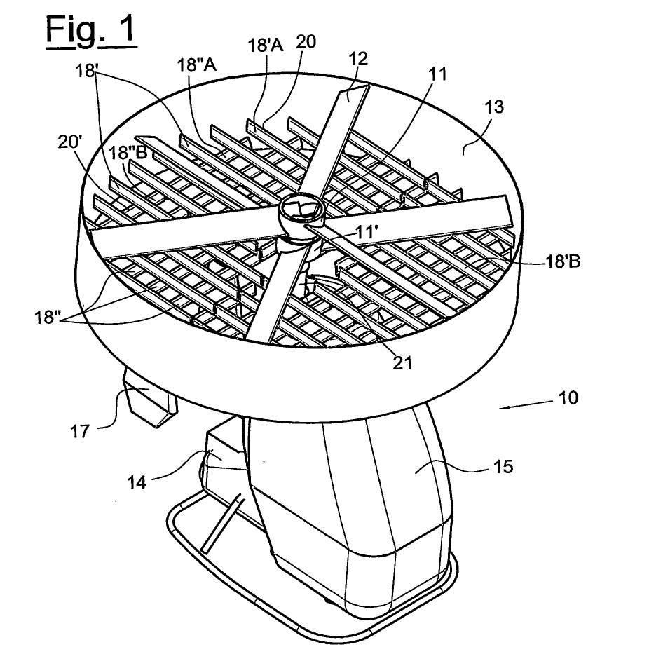

FIG. 1 is a schematic perspective top view of an embodiment of a compact single or double seat aircraft, remote controlled without people on board, with a rotating wing according to the invention;

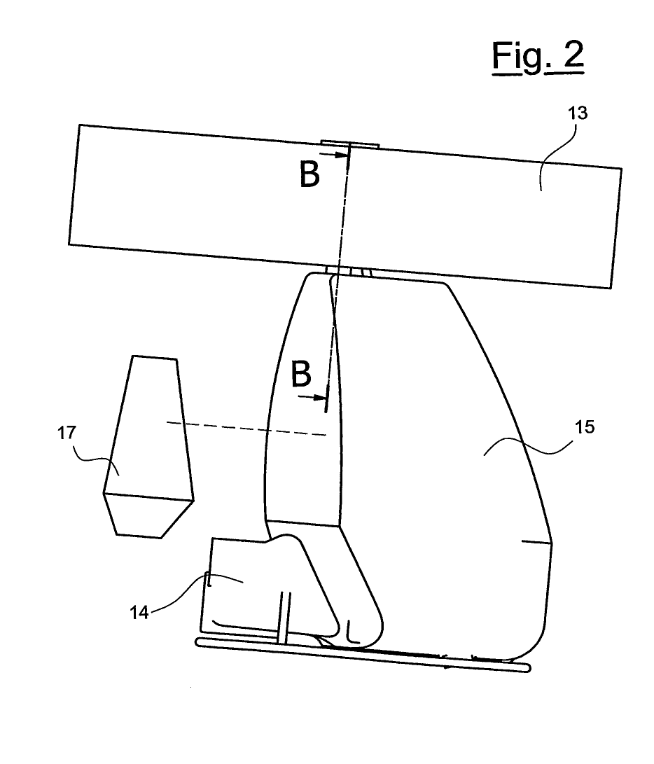

FIG. 2 is a side view of the single or double seat aircraft, remote controlled without people on board, of FIG. 1;

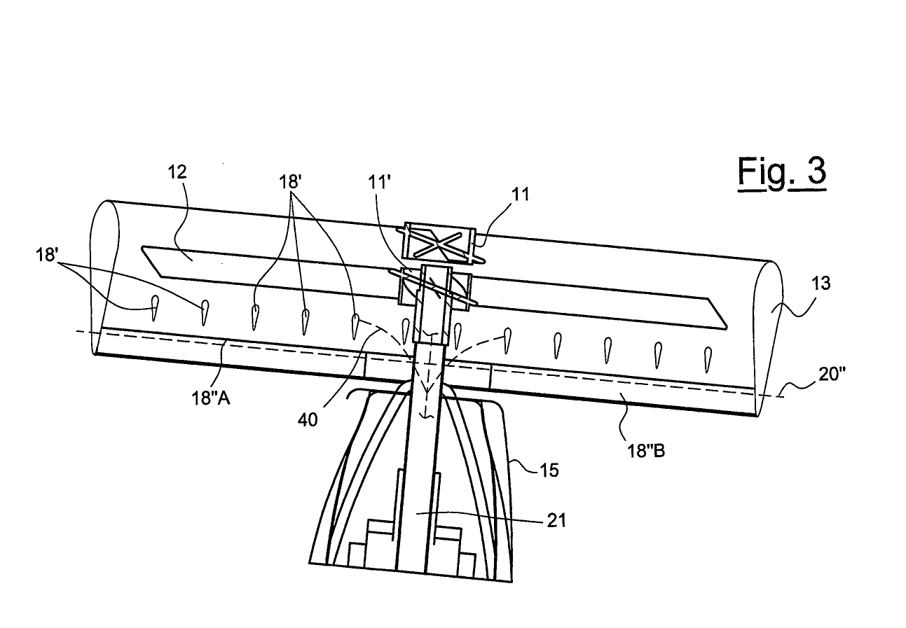

FIG. 3 is a view in partial section of the single or double seat aircraft, remote controlled without people on board, of FIG. 1 along the line B-B shown in FIG. 2;

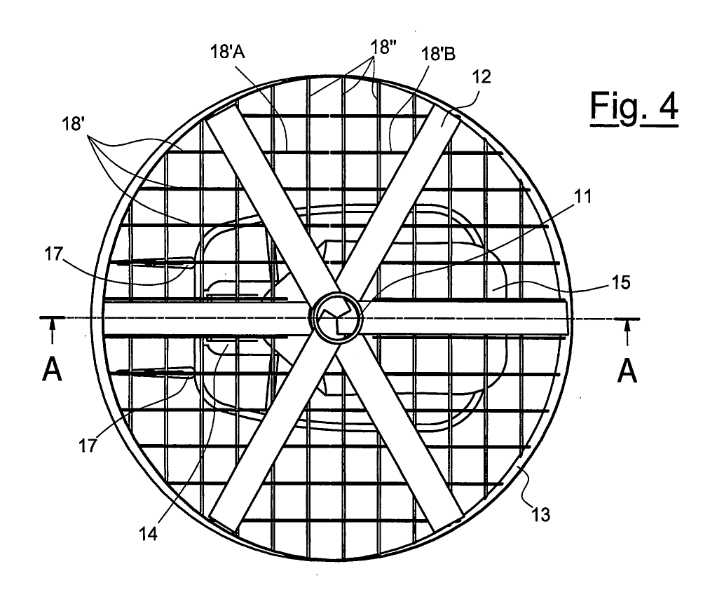

FIG. 4 is a top view of the single or double seat aircraft, remote controlled without people on board, of FIG. 1; and

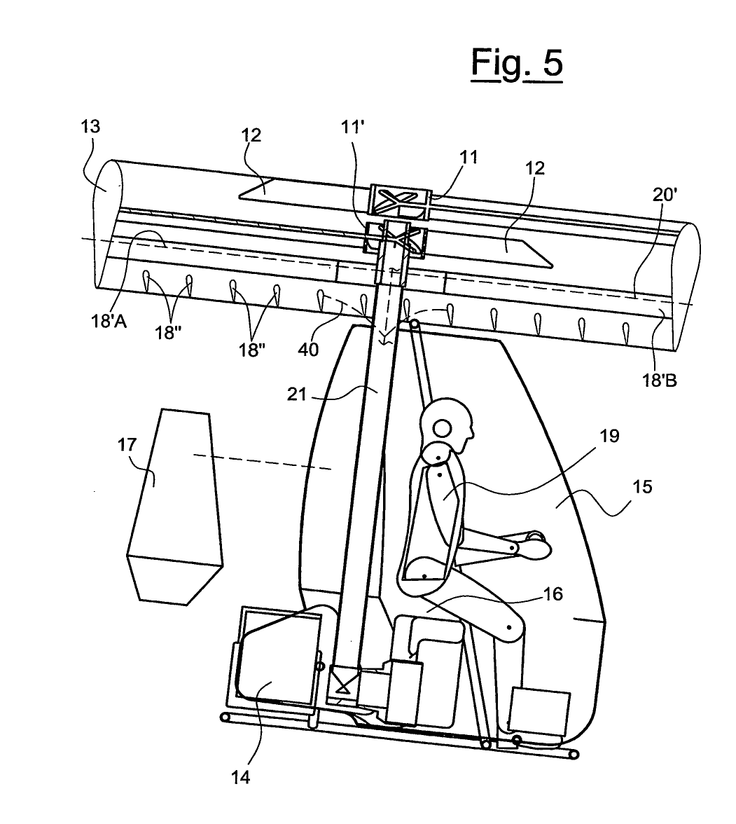

FIG. 5 is a section view of the single or double seat aircraft, remote controlled without people on board, of FIG. 1 along the line A-A shown in FIG. 4.

With reference to the figures, a compact single or double seat aircraft, remote controlled without people on board, is indicated by 10.

The aircraft 10 according to the present invention is an extremely light aircraft, which can be classified within the ultralight category with a maximum weight of approximately 300-350 kg, and very small in terms of dimensions.

Such aircraft is not provided with the tail rotor due to the abovementioned dimension, weight and safety reasons and in order to guarantee equilibrium and the thrust required to keep the aircraft in flight, is provided with two coaxial counter-rotating rotors 11, 11′.

At least two rigid blades 12 are connected to each of the abovementioned two counter-rotating rotors 11, 11′, thus substantially defining the overall dimensions of the aircraft 10.

As a matter of fact, the overall dimensions of the aircraft described herein can be entirely contained in a cylinder with a maximum base diameter of 4.5 metres, and with height of approximately 2 metres.

Advantageously the aircraft 10 can also be of the type controlled remotely without people on board and in such case the abovementioned dimensions can be of very small size similar to the ones commonly known for aircraft modelling.

According to the embodiment described above, the aircraft 10 controlled remotely without people on board is particularly suitable for video surveillance operations in areas inaccessible for aircrafts of bigger dimensions or for controlling areas highly risky for the possible pilot of the aircraft himself.

The two abovementioned rotors 11, 11′ can have a variable or constant plane of rotation, just like the rigid blades 12 themselves can have a variable or fixed blade angle.

Both the coaxial counter-rotating rotors 11, 11′ and the rigid blades 12 connected to them are ducted in a cylindrical structure 13 of a radius slightly greater with respect to the size of said rigid blades 12 thus. shielding them towards the exterior, enhancing safety when the aircraft is on the ground. In addition, such cylindrical structure 13 also improves the aerodynamic. performance.

The two coaxial counter-rotating rotors 11, 11′ are rotated by an engine 14 to which they are connected through driving means 21, such as a rotating shaft.

The traction generated by the two counter-rotating rotors 11, 11′ can vary in various ways. For example, it is possible to provide a collective variation of the pitch of the blades or the variation of the number of revolutions of the engine 14.

In case the aircraft 10 is intended for transporting at least one person, the aircraft 10 comprises a compartment 15 which is rigidly connected to the cylindrical structure 13 and contains at least one seat 16 which represents the pilot's cockpit 19; alternatively there can also be another seat 16 for a second passenger.

otherwise, in case the aircraft 10 is of the type controlled remotely. without people on board, an embodiment particularly suitable to perform video surveillance operations in areas inaccessible for aircrafts of bigger dimensions or for controlling areas highly risky for the possible pilot of the aircraft himself, the abovementioned compartment 15 rigidly connected to the cylindrical structure 13 can be provided with facilities such as video cameras or sensors, adapted to perform the abovementioned surveillance and control operations.

Advantageously, the compartment 15 is positioned below the said two coaxial counter-rotating rotors 11, 11′ in such a manner to create a stable relative alignment between the centre of thrust (approximately at the level of the rotors) and the centre of gravity of the aircraft 10 (approximately at the level of the pilot).

As a matter of fact, according to the present invention as described above, intended for transporting at least one person, but also in the version controlled remotely without people on board, the centre of thrust is always located at a much higher position with respect to the centre of gravity thus enhancing the performance of the aircraft 10 in terms of stability.

There can be provided at least one fin 17 with the function of lateral/directional stabilisation of the aircraft, which in the embodiment shown mainly extends vertically and it is connected to the compartment 15 at a rear position, as indicated by dashes and dots in FIGS. 2 and 5.

In addition, the aircraft 10 comprises at least two series of parallel rows of flaps 18′, 18″ arranged orthogonal to each other to form a grid.

The rows of flaps 18′, 18″ which compose the at least two rows, are all parallel to each other, joined and contained in the cylindrical structure 13 in various cylindrical sections arranged one over the other.

Each of these parallel rows according to the invention is composed by at least two flaps 18′A 18′B; 18″A 18″B arranged in series to each other.

Of these at least two series of parallel rows of flaps 18′, 18″ at least one, in FIG. 1 series 18′, is arranged longitudinally with respect to the direction of motion of the aircraft 10 on which it is mounted.

On all the flaps 18′A 18′B; 18″A 18″B, which compose the two series 18′, 18″, some special rotations commanded by the pilot through the connection elements 40 are allowed.

The first type of rotation allowed is the one which, for example, leads the flaps 18′A, 18′B of a row of flaps of series 18′ to perform in a joint manner an angular motion with respect to the said cylindrical structure 13 as if each row formed a single rigid rotating body.

Such rotation occurs around an axis, indicated by dashed lines by 20′ for series 18′ and 20″ for series 18″, which generally crosses longitudinally each row forming the at least two series of flaps 18′ and 18″ in a position close to their upper ends.

In addition, another rotation is allowed, that is there can be a relative angular motion between the flaps, for example 18′A and 18′B which compose the same row of series 18′.

As mentioned above the at least two series of parallel rows of flaps 18′ 18″ are contained in cylindrical structure 13 in various cylindrical sections arranged one over the other but, according to two different embodiments, they can be positioned above or below the two coaxial counter-rotating rotors (11, 11′).

In case the at least two series of parallel rows of flaps 18′ 18″ are arranged below the two coaxial counter-rotating rotors (11, 11′), example shown in the figures, the grid is provided with a central portion adapted to allow the passage of the driving means 21 of the rotational motion from the engine 14 to the two coaxial counter-rotating rotors (11, 11′).

It is extremely easy to understand the operation of the device subject of the invention.

The controllability of the aircraft 10 in flight, that is the control of the motion of the same around a longitudinal axis of motion, rotation of roll, the movement around the transverse axis on motion, pitch rotation, and the control of the movement around the axis orthogonal to the plane on which the aircraft moves, yaw axis, and the generation of forces in the side and longitudinal planes of the aircraft depends on the arrangement and the rotations of the rows of flaps which form the at least two series 18′ 18″ and the relative rotations between the flaps, for example, 18′A and 18′B which form a row of series 18′.

Control on the roll axis and generation of side forces depends on the rotation of the rows of flaps 18′, intended as rigid bodies that is hindering the relative rotations between the flaps which compose the same row, arranged along the direction of motion of the aircraft. As a matter of fact, due to this particular rotation particular side forces and resulting torques are generated around the roll axis.

Control on the pitch and longitudinal axis depends on the rotation of the rows of flaps 18″, intended as rigid bodies, that is hindering the relative rotations between the flaps which compose the same row, arranged along the direction transverse to the motion of the aircraft. As a matter if fact, due to this particular rotation longitudinal forces and resulting torques are generated around the pitch axis such to allow the motion of the aircraft.

Control on the yaw axis depends on the relative angular positions of the flaps, for example 18′A and 18′B, which compose the same row.

As a matter of fact, due to this special “relative” rotation particular torques capable of equilibrating and rotating the aircraft along the yaw axis are generated.

In this manner the objective of manufacturing a compact single or double seat aircraft, remote controlled without people on board, with a rotating wing, whose controllability is ensured by two series of rows of flaps arranged orthogonal to each other is attained.

Furthermore, advantageously such compact single or double seat aircraft, remote controlled without people on board, reduces problems regarding risks involved in using the tail rotor, omitted herein and replaced by the two counter-rotating rotors, and problems regarding the presence of big rotors in motion at human height, replaced by two small rotors shielded by a cylindrical structure.

It has thus been seen that a compact single or double seat aircraft, remote controlled without people on board, with a rotating wing according to the present invention attains the objectives described above.

The compact single or double seat aircraft, remote controlled without people on board, with a rotating wing thus conceived according to the present invention is susceptible to several modifications and variants, all falling within the same inventive concept.

In addition, in practice the material used, alongside the sizes and components, may vary depending on the technical requirements.

1. Compact ultralight aircraft (10), comprising two coaxial counter-rotating rotors (11, 11′), to each one which at least two rigid blades (12) are connected, centrally ducted in a cylindrical structure (13), of a radius substantially slightly greater than the size of said rigid blades (12) , and rotated by an engine (14) , through driving means (21) , a compartment (15) rigidly connected to said cylindrical structure (13), said aircraft (10) further comprising at least two series of parallel rows of flaps (18′, 18″) arranged orthogonal to each other to form a grid, said at least two series of parallel rows of flaps (18′, 18″) being joined and contained in said cylindrical structure (13) in various cylindrical sections one over the other, each of said parallel rows (18′, 18″) being composed by at least two of said flaps (18′A, 18′B; 18″A, 18″B) in series.

2. Ultralight compact aircraft (10) according to claim 1 characterised in that it comprises at least one seat (16) in said compartment (15) for transporting at least one person (19).

3. Ultralight compact aircraft (10) according to claim 1 characterised in that it comprises at least one stabilising fin (17)

4. Aircraft (10) according to claim 1 characterised in that said two coaxial counter-rotating rotors (11, 11′) have a variable plane of rotation.

5. Aircraft (10) according to claim 1 characterised in that said rigid blades (12) have a variable blade pitch angle.

6. Aircraft (10) according to claim 1 characterised in that one (18′) of said at least two series of parallel rows of flaps (18′, 18″) is arranged longitudinally to the direction of motion of said aircraft (10).

7. Aircraft (10) according to claim 6 characterised in that said at least two flaps (18′A, 18′B; 18″A, 18″B) of each said row (18′, 18″) rotate with respect to said cylindrical structure (13) integrally between them to form a single rigid body rotating around an axis (20′, 20″) crossing it longitudinally.

8. Aircraft (10) according to claim 7 characterised in that each said flap (18′A, 18′B; 18″A, 18″B) of each said row (18′, 18″) rotates, around said axis (20′, 20″), in an independent manner with respect to said at least another flap (18′A, 18′B; 18″A, 18″B) which completes the same row.

9. Aircraft (10) according to claim 8 characterised in that said axes (20′, 20″) longitudinally cross each said row of flaps (18′, 18″) in a position close to its upper end.

10. Aircraft (10) according to claim 9 characterised in that said compartment (15) is arranged below said two coaxial counter-rotating rotors (11, 11′).

11. Aircraft (10) according to claim 10 characterised in that said at least one stabilising fin (17) mainly extends vertically and it is connected to said compartment (15) at a rear position.

12. Compact aircraft (10) according to claim 11 characterised in that said at least two series of parallel rows of flaps (18′, 18″) are arranged above said two coaxial counter-rotating rotors (11, 11′).

13. Aircraft (10) according to claim 11 characterised in that said at least two series of parallel rows of flaps (18′, 18″) are arranged below said two coaxial counter-rotating rotors (11, 11′).

14. Aircraft (10) according to claim 13 characterised in that said grid formed by said at least two series of parallel rows of flaps (18′, 18″) is provided with a central portion in which said flaps (18′A, 18′B; 18″A, 18″B) which form said parallel rows of flaps (18′, 18″) have a length such to allow passage of said driving means (21) of the rotational motion from said engine (14) to said two coaxial counter-rotating rotors (11, 11′).

15. Aircraft (10) according to claim 14 characterised in that said driving means (21) of the rotational motion from said engine (14) to said two coaxial counter-rotating rotors (11, 11′), are a rotating shaft.
